(19) United States
(12) Patent Application Publication
(10) Pub. No.: US 2011/0082695 A1
(43) Pub. Date: Apr. 7, 2011

(54) METHODS, ELECTRONIC DEVICES, AND COMPUTER PROGRAM PRODUCTS FOR GENERATING AN INDICIUM THAT REPRESENTS A PREVAILING MOOD ASSOCIATED WITH A PHONE CALL

(75) Inventor: Emil Morgan Billing Bengt, Svalov (SE)

(73) Assignee: Sony Ericsson Mobile Communications AB

(21) Appl. No.: 12/572,539

(22) Filed: Oct. 2, 2009

(51) Int. Cl. G10L 15/00; H04M 1/64; H04M 11/00; G06F 17/27

(52) U.S. Cl. 704/236; 379/88.01; 379/88.14; 704/9; 704/E15.014

(57) ABSTRACT

An electronic device includes a call analysis module that is configured to analyze characteristics of a phone call and to generate an indicium that represents a prevailing mood associated with the phone call based on the analyzed characteristics.

### BACKGROUND OF THE INVENTION

The present invention relates to electronic devices, and, more particularly, to methods, electronic devices, and computer program products for character.

Telephones, such as cellular phones, often maintain lists of recent calls, missed calls, and attempted calls. Such lists may provide a convenient way for a phone user to return a missed call, to re-dial a frequently called party, and/or to remember the last time the user spoke to a particular person. These call lists, however, do not generally convey any information about the nature of the particular calls other than the time and date the calls were made and possibly the duration of the calls.

### SUMMARY

According to some embodiments of the present invention, an electronic device comprises a call analysis module that is configured to analyze characteristics of a phone call and to generate an indicium that represents a prevailing mood associated with the phone call based on the analyzed characteristics.

In other embodiments, the call analysis module comprises an audio analysis module that is configured to analyze speech associated with a calling party and/or a called party so as to determine the prevailing mood associated with the phone call.

In still other embodiments, the audio analysis module is configured to perform a textual analysis of the speech so as to determine the prevailing mood associated with the phone call.

In still other embodiments, the audio analysis module comprises a speech recognition module that is configured to generate text responsive to the speech, a text correlation module that is configured to correlate the generated text with stored words and/or phrases, and a mood detection module that is configured to determine the prevailing mood associated with the phone call based on the correlation between the generated text and the stored words and/or phrases.

In still other embodiments, the audio analysis module is configured to perform a spectral analysis of the speech so as to determine the prevailing mood associated with the phone call.

In still other embodiments, the audio analysis module comprises a spectral analysis module that is configured to determine frequencies and/or loudness levels associated with the speech, a spectral correlation module that is configured to correlate the determined frequencies and/or loudness levels with frequency and/or loudness patterns, and a mood detection module that is configured to determine the prevailing mood associated with the phone call based on the correlation between the determined frequencies and/or loudness levels and the frequency and/or loudness patterns.

In still other embodiments, the spectral analysis module is further configured to determine frequencies and/or loudness levels associated with ambient noise, the spectral correlation module is further configured to correlate the determined frequencies and/or loudness levels associated with the ambient noise with frequency and/or loudness patterns associated with ambient noise, and the mood detection module is further configured to determine the prevailing mood associated with the phone call based on the correlation between the determined frequencies and/or loudness levels associated with the ambient noise and the frequency and/or loudness patterns associated with the ambient noise.

In still other embodiments, the audio analysis module comprises a cadence analysis module that is configured to determine cadences associated with the speech, a cadence correlation module that is configured to correlate the determined cadences with cadence patterns, and a mood detection module that is configured to determine the prevailing mood associated with the phone call based on the correlation between the determined cadences and the cadence patterns.

In still other embodiments, the audio analysis module is configured to perform a textual and a spectral analysis on the speech so as to determine the prevailing mood associated with the phone call.

In still other embodiments, the audio analysis module is further configured to perform a spectral analysis on ambient noise so as to determine the prevailing mood associated with the phone call.

In still other embodiments, the audio analysis module is further configured to determine cadences associated with the speech so as to determine the prevailing mood associated with the phone call.

In still other embodiments, the call analysis module comprises a call characteristics module that is configured to determine a number of instances when a calling party and a called party talk at the same time and/or a duration of the phone call so as to determine the prevailing mood associated with the phone call.

In still other embodiments, the call analysis module is further configured to make the indicium representing the prevailing mood associated with the phone call available to at least one application running on the electronic device.

In still other embodiments, the call analysis module is further configured to communicate the indicium to an application outside of the electronic device via a communication network.

In still other embodiments, the indicium representing the prevailing mood associated with the phone call further represents at least one change in the prevailing mood associated with the phone call during the call.

In still other embodiments, the electronic device is a mobile terminal.

In further embodiments of the present invention, an electronic device is operated by analyzing characteristics of a phone call and generating an indicium that represents a prevailing mood associated with the phone call based on the analyzed characteristics.

In still further embodiments, analyzing characteristics of the phone call comprises at least one of the following: performing a textual and/or a spectral analysis on speech associated with a calling party and/or a called party so as to determine the prevailing mood associated with the phone call; performing a spectral analysis on ambient noise so as to determine the prevailing mood associated with the phone call; determining cadences associated with the speech so as to determine the prevailing mood associated with the phone call; determining a number of instances when the calling party and the called party talk at the same time so as to determine the prevailing mood associated with the phone call; and determining a duration of the phone call so as to determine the prevailing mood associated with the phone call.

In still further embodiments, the electronic device is a mobile terminal.

In other embodiments of the present invention, a computer program product for operating an electronic device comprises a computer readable storage medium having computer readable program code embodied therein. The computer readable program code comprises computer readable program code configured to analyze characteristics of a phone call and computer readable program code configured to generate an indicium that represents a prevailing mood associated with the phone call based on the analyzed characteristics.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an electronic device/mobile terminal in accordance with some embodiments of the present invention;

FIG. 2 is a block diagram that illustrates audio, cadence, and call characteristics analysis modules in accordance with some embodiments of the present invention; and

FIGS. 3 and 4 are flow charts that illustrate generating an indicium that represents a prevailing mood associated with a phone call in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that can be used to establish voice communication with one or more parties.

Some embodiments of the present invention stem from a realization that while many mobile terminals offer a capability of maintaining a list of recent calls, the list typically includes only data, such as date and time the call occurred, duration of the call, phone number of the other party, and name of the other party. It may be desirable to associate some type of indicium with the call that represents the prevailing mood associated with the call. For example, it may be helpful to a phones user to have an indication that the last call with a relative was a serious call or the last call with a significant other was a happy call. According to some embodiments of the present invention, a mobile terminal may analyze characteristics of a phone call, including, but not limited to, the speech of the calling and called parties, the cadence of the calling and called parties, the ambient noise present on the phone call, the number of times the calling and called parties talk over each other, i.e., talk at the same time, and/or the duration of the phone call. A prevailing mood may be determined based on analyzing these characteristics of the call and an indicium can be generated that represents the prevailing mood. For example, a green icon with bubbles may be generated for a happy conversation with laughter while a red and black icon with zig-zag patterns may be generated for an angry conversation with harsh words exchanged. These icons can be associated with the call records in a call list, contact list, calendar, and/or other application to help a phone user remember the nature of previous calls with particular parties. In some embodiments, the indicium generated for a particular call may be provided to one or more applications on the mobile terminal or on other devices. For example, a user may wish to set the emoticon or icon associated with an instant messenger application running on the mobile terminal based on the prevailing mood of the user's most recent call or the prevailing mood associated with the most recent call with a particular party. A user may also wish to update an emoticon or icon associated with a Web page hosted by a social networking site based on the prevailing mood of the user's most recent call or the prevailing mood associated with the most recent call with a particular party.

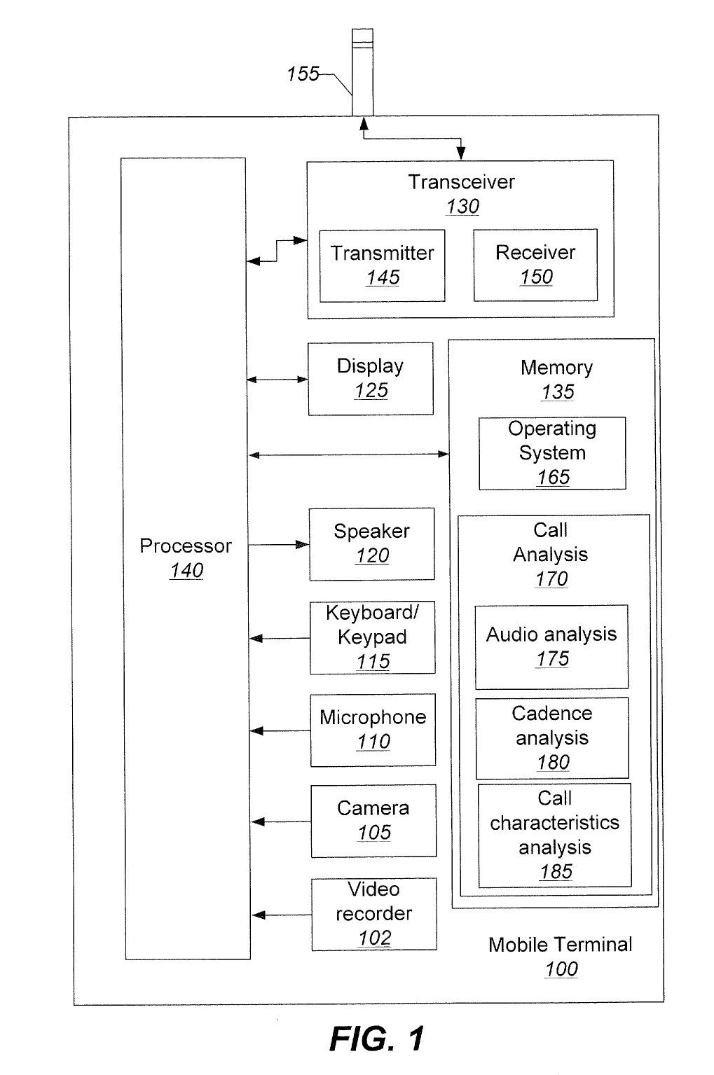

Referring now to FIG. 1, an exemplary mobile terminal 100, in accordance with some embodiments of the present invention, comprises a video recorder 102, a camera 105, a microphone 110, a keyboard/keypad 115, a speaker 120, a display 125, a transceiver 130, and a memory 135 that communicate with a processor 140. The transceiver 130 comprises a transmitter circuit 145 and a receiver circuit 150, which respectively transmit outgoing radio frequency signals to base station transceivers and receive incoming radio frequency signals from the base station transceivers via an antenna 155. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100 may be included in many conventional mobile terminals and their functionality is generally known to those skilled in the art.

The processor 140 communicates with the memory 135 via an address/data bus. The processor 140 may be, for example, a commercially available or custom microprocessor. The memory 135 is representative of the one or more memory devices containing the software and data used to generate an indicium that represents a prevailing mood associated with a phone call made using the mobile terminal 100 based on an analysis of one or more characteristics of the call, in accordance with some embodiments of the present invention. The memory 135 may include, but is not limited to, the following types of devices: cache, ROM, PROM, EPROM, EEPROM, flash, SRAM, and DRAM.

As shown in FIG. 1, the memory 135 may contain up to two or more categories of software and/or data: the operating system 165 and a call analysis module 170. The operating system 165 generally controls the operation of the mobile terminal 100. In particular, the operating system 165 may manage the mobile terminal's software and/or hardware resources and may coordinate execution of programs by the processor 140. The call analysis module 170 comprises an audio analysis module 175, a cadence analysis module 180, and a call characteristics analysis module 185. The audio analysis module 175 may be configured to perform an audio analysis of speech associated with a calling and a called party participating in a phone call by performing a spectral analysis of the frequencies and/or loudness levels associated with the phone call participants' speech, which can be used to determine a prevailing mood associated with the phone call. The audio analysis module 175 may also perform a spectral analysis of the frequencies and/or loudness levels of the ambient noise present during the call, which can be used to determine a prevailing mood associated with the phone call. In some embodiments, the audio analysis module may be configured to perform a textual analysis of the phone call participants' speech by using speech recognition, for example, to generate text that can be correlated with stored words and/or phrases, which can be used to determine a prevailing mood associated with the phone call. The cadence analysis module 180 may be configured to determine the cadences of the phone call participants' speech, which can be used to determine a prevailing mood associated with the phone call. The call characteristics analysis module 185 may be configured to analyze other characteristics of a phone call, which analysis can be used to determine a prevailing mood associated with the phone call. Such characteristics may include, but are not limited to, the duration of the phone call and a number of times that the participants in the phone call talk at the same time, e.g., talk over or interrupt each other.

Although FIG. 1 illustrates an exemplary software and hardware architecture that may be used for setting a feature of a mobile terminal based on an analysis of one or more characteristics of a user, such as a user's voice or expression, which may be indicative of the user's mood, it will be understood that the present invention is not limited to such a configuration but is intended to encompass any configuration capable of carrying out the operations described herein.

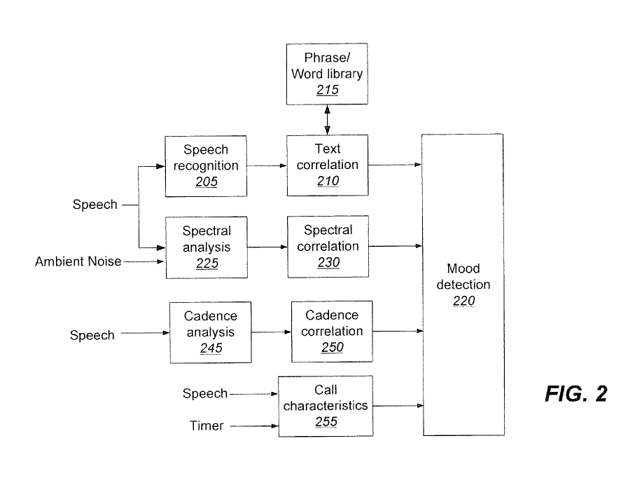

FIG. 2 is a block diagram that illustrates the call analysis module 170 of FIG. 1 in more detail in accordance with some embodiments of the present invention. A phone call participants' speech can be captured and provided to a speech recognition module 205 that is configured to generate text responsive to the captured speech. A text correlation module 210 may then process the generated text by correlating the generated text with words and/or phrases that are stored in the phrase/word library 215. For example, words and/or phrases from the generated text may be correlated with words and/or phrases in the phrase/word library 215 that have moods, such as angry, happy, sad, afraid, and the like associated with them. Based on the correlations established between the generated text and the phrases/words from the library 215, a mood detection module 220 may determine a prevailing mood associated with the phone call.

The phone call participants' speech may also be analyzed spectrally by the spectral analysis module 225. That is, the spectral analysis module 225 may determine frequencies and/or loudness levels associated with the captured speech. A spectral correlation module 230 may correlate the determined frequencies and/or loudness levels with frequency and/or loudness patterns that are indicative of the participants' moods, such as angry, happy, sad, afraid, and the like. The mood detection module 220 may determine a prevailing mood associated with the phone call based on the correlation between the frequencies and/or loudness levels and the patterns that are indicative of a person's mood. In addition to performing a spectral analysis on the voices of the phone call participants, the spectral analysis module 225 may also determine frequencies and/or loudness levels of the ambient noise environment associated with the phone call. The spectral correlation module 230 may correlate the determined frequencies and/or loudness levels with ambient noise frequency and/or loudness patterns that are indicative of the participants' moods. For example, an analysis of the ambient noise may indicate that one or both of the participants on a phone call are at a party or a fun event, which may be indicative that the participants are in a happy mood. The mood detection module 220 may determine a prevailing mood associated with the phone call based on the correlation between the ambient noise frequencies and/or loudness levels and the ambient noise patterns that are indicative of a person's mood.

The phone call participants' speech may also be provided to a cadence analysis module 245, which analyzes the cadence of the participants' voices. A cadence correlation module 250 may correlate the determined cadences of the participants' voices with cadence patterns that are indicative of the participants' moods, such as angry, happy, sad, afraid, and the like. The mood detection module 220 may determine a prevailing mood associated with the phone call based on the correlation between the cadences of the participants' voices and the cadence patterns.

A call characteristics module 255 may analyze other characteristics of a phone call, such as, but not limited to, a number of times that the participants speak at the same time, e.g., talk over each other or interrupt each other, and a duration of the phone call. The mood detection module 220 may use this determined information to determine a prevailing mood associated with the phone call.

As discussed above, an indicium, such as, for example, an icon, emoticon, code, picture, and the like can be generated that represents the prevailing mood determined by the mood detection module 220 and which may be displayed on a display device.

Although FIGS. 1 and 2 illustrate exemplary hardware/software architectures that may be used in mobile terminals, electronic devices, and the like for analyzing characteristics of a phone call to generate an indicium that represents a prevailing mood associated with the phone call, it will be understood that the present invention is not limited to such a configuration but is intended to encompass any configuration capable of carrying out operations described herein. Moreover, the functionality of the hardware/software architecture of FIGS. 1 and 2 may be implemented as a single processor system, a multi-processor system, or even a network of stand-alone computer systems, in accordance with various embodiments of the present invention.

Computer program code for carrying out operations of devices and/or systems discussed above with respect to FIGS. 1 and 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations of analyzing characteristics of a phone call to generate an indicium that represents a prevailing mood associated with the phone call, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

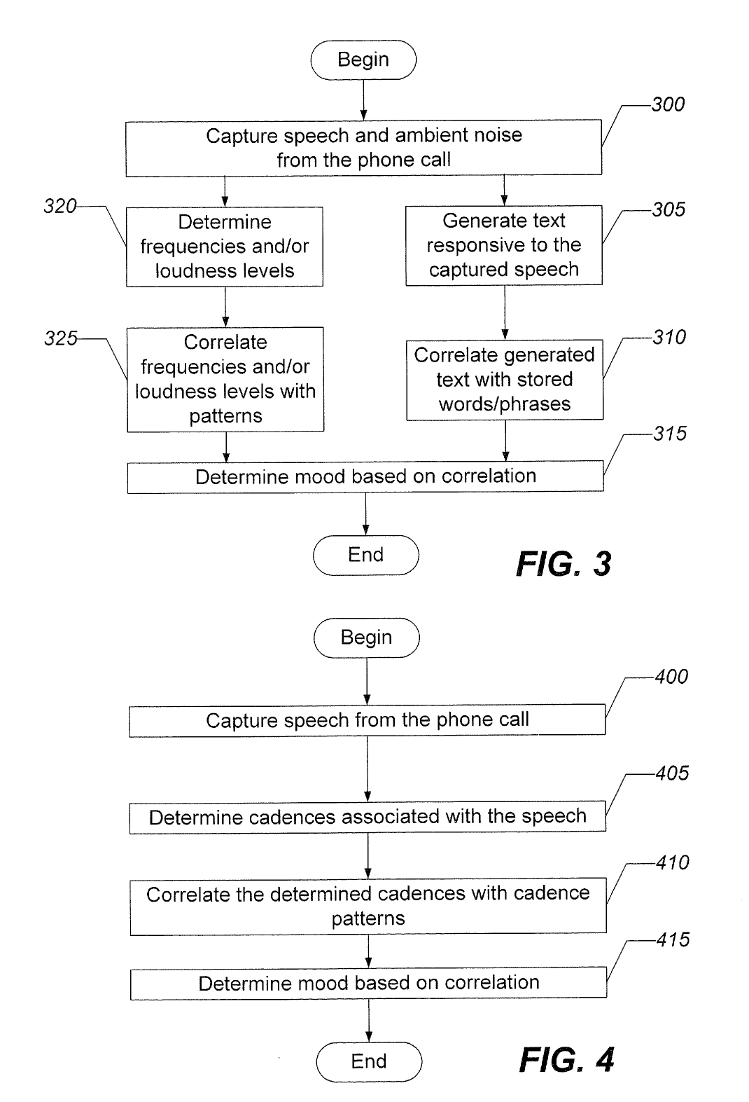

Referring now to FIG. 3, operations for analyzing the captured speech of participants and/or ambient noise associated a phone call so as to determine a prevailing mood associated with the phone call begin at block 300 where the speech and/or ambient noise is captured. At block 305, a textual analysis of the captured speech can be performed by generating text responsive to the captured speech using the speech recognition module 205 of FIG. 2. The generated text can be correlated with stored words/phrases at block 310 using the text correlation module 210 and phrase/word library 215 of FIG. 2. A prevailing mood associated with the phone call may then be determined at block 315 based on the correlation performed at block 310 using the mood detection module 220 of FIG. 2.

In addition to or instead of performing a textual analysis of the captured speech, the frequencies and/or loudness levels of the captured speech and/or ambient noise can be determined at block 320 using the spectral analysis module 225 of FIG. 2. The spectral analysis module 225 may be, for example, a fast Fourier transform (FFT) module in some embodiments. The determined frequencies and/or loudness levels of the captured speech and/or ambient noise can be correlated with frequency and/or loudness patterns at block 325 using the spectral correlation module 230 of FIG. 2. A prevailing mood associated with the phone call may then be determined at block 315 based on the correlation performed at block 325 using the mood detection module 220 of FIG. 2.

Referring now to FIG. 4, operations for analyzing the cadence of a phone call participants' speech so as to determine a prevailing mood associated with the phone call begin at block 400 where participants' is captured. The cadences associated with the participants' speech are determined at block 405 using the cadence analysis module 245 of FIG. 2. The determined cadences can be correlated with cadence patterns at block 410 using the cadence correlation module 250 of FIG. 2. A prevailing mood associated with the phone call may then be determined at block 415 based on the correlation performed at block 410 using the cadence correlation module 250 of FIG. 2.

It will be understood that, in accordance with various embodiments of the present invention, a voice/speech analysis may be performed on a phone call participants' captured speech, a cadence analysis may be performed on a phone call participants' captured speech, and/or an analysis of other characteristics of a phone call may be performed, such as duration of the call and a number of times that participants to a call talk at the same time to determine a prevailing mood associated with a phone call. Moreover, when performing a voice/speech analysis, a text analysis may be performed, a spectral analysis may be performed, or both a text analysis and a spectral analysis may be performed to determine a prevailing mood of a phone call. Moreover, in some embodiments, an indicium representing the prevailing mood may further represent at least one change in the prevailing mood that occurred during the call. For example, the indicium may indicate that the prevailing mood at the beginning of the call was happy, but at the conclusion of the call the prevailing mood had changed to angry.

Advantageously, some embodiments of the present invention may allow devices, such as mobile terminals, to determine a prevailing mood associated with a phone call and provide an indicium representing that prevailing mood to one or more applications running on the device. For example, the indicium could be provided to an application that maintains a recent call list so that a called is stored in the list with the accompanying indicium, such as an icon that is displayed on a display device, so that the phone user can relatively easily tell how a previous call went with a particular party or parties. Moreover, the indicium could also be provided to applications, such as a calendar or contacts list. This may allow a user to tell that on a given day the user had several happy, sad, angry, etc. phone calls. When used with a contact list, the indicium representing the prevailing mood of a phone call may allow a phone user to tell quickly how a previous call to a particular user went.

In still other embodiments, the indicium representing the prevailing mood of a phone call may be incorporated into one or more features of the device, such as ringtones, display backgrounds, icons in messages, and/or other themes of the device.

In further embodiments of the present invention, an indicium representing the prevailing mood of a phone call may be made available to others to see via, for example, various services on the Internet. One type of service may be an instant messaging service in which a person may see which friends of him/her are online at the moment along with their moods, which may be based on a recent phone call as discussed above. Another type of service may be a push-to-talk service in which a person can see which friends are available for communication, e.g., online, and their moods, which may be based on recent phone calls, before the person attempts to set up a push-to-talk session. In other embodiments, conventional messaging, instant messaging, and/or push-to-talk services may be combined. The indicium representing the prevailing mood of a phone call may also be made available to applications residing outside the electronic device on which it was generated. For example, the indicium representing the prevailing mood of a phone call may be communicated over a communication network to a server that hosts a social networking application where the indicium may be viewed by other visitors to the site. In this manner, a user may publish how his/her calls have gone with friends, acquaintances, and the like, or may simply use the indicium as an indicator of the user's current mood. In other example embodiments, the indicium representing the prevailing mood of a phone call may be included as part of a Multimedia Messaging Service (MMS) messages that is sent from one electronic device to another electronic device.

The flowcharts of FIGS. 3 and 4 illustrate the architecture, functionality, and operations of embodiments of methods, electronic devices, and/or computer program products for generating an indicium that represents the prevailing mood of a phone call. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. An electronic device, comprising:
a call analysis module that is configured to analyze characteristics of a phone call and to generate an indicium that represents a prevailing mood associated with the phone call based on the analyzed characteristics.

2. The electronic device of claim 1, wherein the call analysis module comprises an audio analysis module that is configured to analyze speech associated with a calling party and/or a called party so as to determine the prevailing mood associated with the phone call.

3. The electronic device of claim 2, wherein the audio analysis module is configured to perform a textual analysis of the speech so as to determine the prevailing mood associated with the phone call.

4. The electronic device of claim 3, wherein the audio analysis module comprises:
a speech recognition module that is configured to generate text responsive to the speech;
a text correlation module that is configured to correlate the generated text with stored words and/or phrases; and
a mood detection module that is configured to determine the prevailing mood associated with the phone call based on the correlation between the generated text and the stored words and/or phrases.

5. The electronic device of claim 2, wherein the audio analysis module is configured to perform a spectral analysis of the speech so as to determine the prevailing mood associated with the phone call.

6. The electronic device of claim 5, wherein the audio analysis module comprises:
a spectral analysis module that is configured to determine frequencies and/or loudness levels associated with the speech;
a spectral correlation module that is configured to correlate the determined frequencies and/or loudness levels with frequency and/or loudness patterns; and
a mood detection module that is configured to determine the prevailing mood associated with the phone call based on the correlation between the determined frequencies and/or loudness levels and the frequency and/or loudness patterns.

7. The electronic device of claim 6, wherein the spectral analysis module is further configured to determine frequencies and/or loudness levels associated with ambient noise, the spectral correlation module is further configured to correlate the determined frequencies and/or loudness levels associated with the ambient noise with frequency and/or loudness patterns associated with ambient noise, and the mood detection module is further configured to determine the prevailing mood associated with the phone call based on the correlation between the determined frequencies and/or loudness levels associated with the ambient noise and the frequency and/or loudness patterns associated with the ambient noise.

8. The electronic device of claim 2, wherein the audio analysis module comprises:
a cadence analysis module that is configured to determine cadences associated with the speech;
a cadence correlation module that is configured to correlate the determined cadences with cadence patterns; and
a mood detection module that is configured to determine the prevailing mood associated with the phone call based on the correlation between the determined cadences and the cadence patterns.

9. The electronic device of claim 2, wherein the audio analysis module is configured to perform a textual and a spectral analysis on the speech so as to determine the prevailing mood associated with the phone call.

10. The electronic device of claim 9, wherein the audio analysis module is further configured to perform a spectral analysis on ambient noise so as to determine the prevailing mood associated with the phone call.

11. The electronic device of claim 10, wherein the audio analysis module is further configured to determine cadences associated with the speech so as to determine the prevailing mood associated with the phone call.

12. The electronic device of claim 1, wherein the call analysis module comprises a call characteristics module that is configured to determine a number of instances when a calling party and a called party talk at the same time and/or a duration of the phone call so as to determine the prevailing mood associated with the phone call.

13. The electronic device of claim 1, wherein the call analysis module is further configured to make the indicium representing the prevailing mood associated with the phone call available to at least one application running on the electronic device.

14. The electronic device of claim 1, wherein the call analysis module is further configured to communicate the indicium to an application outside of the electronic device via a communication network.

15. The electronic device of claim 1, wherein the indicium representing the prevailing mood associated with the phone call further represents at least one change in the prevailing mood associated with the phone call during the call.

16. The electronic device of claim 1, wherein the electronic device is a mobile terminal.

17. A method of operating an electronic device, comprising:
analyzing characteristics of a phone call; and
generating an indicium that represents a prevailing mood associated with the phone call based on the analyzed characteristics.

18. The method of claim 17, wherein analyzing characteristics of the phone call comprises at least one of the following:
performing a textual and/or a spectral analysis on speech associated with a calling party and/or a called party so as to determine the prevailing mood associated with the phone call;
performing a spectral analysis on ambient noise so as to determine the prevailing mood associated with the phone call;
determining cadences associated with the speech so as to determine the prevailing mood associated with the phone call;
determining a number of instances when the calling party and the called party talk at the same time so as to determine the prevailing mood associated with the phone call; and
determining a duration of the phone call so as to determine the prevailing mood associated with the phone call.

19. The method of claim 17, wherein the electronic device is a mobile terminal.

20. A computer program product for operating an electronic device, comprising:
a computer readable storage medium having computer readable program code embodied therein, the computer readable program code comprising:
computer readable program code configured to analyze characteristics of a phone call; and
computer readable program code configured to generate an indicium that represents a prevailing mood associated with the phone call based on the analyzed characteristics.
